(19) United States
(12) Patent Application Publication
(10) Pub. No.: US 2018/0044363 A1
(43) Pub. Date: Feb. 15, 2018

(54) Methods and Systems for Post-Fermentation Lignin Recovery

(71) Applicant: BioChemInsights, Inc., Malvem, PA (US)

(72) Inventors: William B. Armiger, Malvern, PA (US); David R. Dodds, Manlius, NY (US)

(21) Appl. No.: 15/555,158

(22) PCT Filed: Mar. 3, 2016
(86) PCT No.: PCT/US16/20782

§ 371 Date: Sep. 1, 2017

Related U.S. Application Data
(60) Provisional application No. 62/127,324, filed on Mar. 3, 2015.

(51) Int. Cl. C07G 1/00; B01D 11/02

(52) U.S. Cl. CPC C07G 1/00; B01D 11/0288

(57) ABSTRACT

Provided herein is process and system for the production of high-quality lignin by treating the post-fermentation solids. In one aspect, the present disclosure relates to a novel process comprising: providing a solid material remaining at the end of a fermentation process, wherein the fermentation process utilizes a lignocellulosic biomass feedstock; extracting lignin from the solid material into a liquid phase; and recovering lignin from liquid phase. In some embodiments, the fermentation process produces one or more of ethanol, n-butanol, iso-butanol, lactic acid, polyhydroxyalkanoates, succinic acid, 1,3-propanediol and 1,4-butanediol. In one embodiment's, the fermentation process produces ethanol.

### CROSS REFERENCE TO RELATED APPLICATIONS

This application claims priority to and the benefit of U.S. Provisional Application No. 62/127,324 filed Mar. 3, 2015, the disclosure of which is incorporated herein by reference in its entirety.

### FIELD

The disclosure relates generally to processing of solids material remaining after fermentation of lignocellulosic feedstock for ethanol and other bio-based chemical production, and specifically to recovery of lignin from such post-fermentation solids material.

### BACKGROUND

Lignin is a naturally occurring, abundant chemical found in woody plants and annual crops, generally termed “lignocellulosic biomass”. It has chemical characteristics similar to aromatic petro-chemicals, such as phenol, styrene, catechol, and similar hydroxylated aromatics. The use of lignin, to supplement or replace petroleum feedstocks has great appeal to the world's industries as the production of lignin is renewable, can provide stability as a raw material versus the volatility of conventional petroleum feedstocks. Its use can also reduce the greenhouse gas footprint of a chemical production facility. It is thus desirable to isolate lignin from lignocellulosic biomass for use as a chemical feedstock.

The pulp and paper industry has practiced methods for deconstructing lignocellulosic materials, most usually wood, to produce purified cellulose fiber. These processes are generally termed “pulping processes” and produce not only cellulose fiber, but other process streams generally termed “liquors” which contain the lignin that was present in the initial lignocellulosic biomass. The two most common processes for obtaining cellulose fiber from lignocellulosic biomass are named the Kraft and Sulfite processes.

Lignin is currently produced almost entirely from paper pulp mills which use the Kraft pulping process or the Sulfite pulping process. Both these processes use sulfur containing reagents to degrade the lignin during the pulping process. As a result, the lignin produced from paper pulp mills is chemically modified with sulfur, and is not suitable for many commercial uses, including use in phenol-formaldehyde resins, as well as feedstock for aromatic chemicals.

Thus, a need exists for methods and systems for producing high-quality lignin.

The desirability of also using lignocellulosic biomass from non-food plants to provide the fermentable sugars for the production of ethanol has been widely acknowledged, and commercial ethanol production facilities using lignocellulosic feedstock are now operated in the United States by DuPont, POET/DSM, and Abengoa, as well as by logen in Brazil and BetaRenewables in Italy. It is generally anticipated that other products now produced by fermentation of starch-derived glucose or of sucrose from sugarcane or sugarbeet, such as n-butanol, iso-butanol, lactic acid, polyhydroxyalkanoates, succinic acid, 1,3-propanediol and 1,4-butanediol, will also be produced using sugars from non-food lignocellulosic biomass.

Lignocellulosic biomass consists of natural occurring complex arrangements of cellulose, hemi-cellulose and lignin in such a manner as to provide mechanical strength to the plant, and to be generally resistant to degradation. To obtain fermentable sugars, these naturally occurring arrangements must be degraded to a level where the cellulose and hemi-cellulose can be hydrolysed to mono- and small oligosaccharides that are capable of being consumed by whatever micro-organism is to be used to generate the desired product by fermentation.

Current processes practiced for the production of ethanol from lignocellulosic biomass pass the biomass through a series of physical, chemical and/or enzymatic steps to release fermentable sugars. The lignin originally present in the lignocellulosic biomass remains thereafter, but is now associated with only approximately 20% of the initial carbohydrate (cellulose and hemi-cellulose) that was present in the starting lignocellulosic biomass. This lignin and the reduced mass of associated carbohydrates remain as solids after the ethanol fermentation has ended.

With the recent start-up of cellulosic ethanol plants in the United States, a need exists for methods and systems to process these post-fermentation solids to produce high-quality lignin.

### SUMMARY

In one aspect, the present disclosure relates to a novel process comprising:

providing a solid material remaining at the end of a fermentation process, wherein the fermentation process utilizes a lignocellulosic biomass feedstock;

extracting lignin from the solid material into a liquid phase; and

recovering lignin from liquid phase.

In some embodiments, the fermentation process produces one or more of ethanol, n-butanol, iso-butanol, lactic acid, polyhydroxyalkanoates, succinic acid, 1,3-propanediol and 1,4-butanediol. In one embodiments, the fermentation process produces ethanol.

In some embodiments, the extracting step operates at approximately 180° C. to 220° C. and approximately 20 to 35 atmospheres of pressure, optionally in the presence of an solvent. The solvent may be ethanol. In certain embodiments, the extracting step takes place in a steam explosion equipment (e.g., batch steam explosion reactor, explosion cylinder).

The process may further comprise removing spent cells from the fermentation process, prior to the extracting step.

In certain embodiments, the recovering step comprises precipitating lignin. Precipitation can be achieved by adding water to the liquid phase and/or boiling off the solvent (e.g., ethanol).

The process can further comprise recovering a carbohydrate material following the extracting step. The carbohydrate material can be recycled back to the fermentation process.

Also provided herein is a system for producing lignin, comprising :

Optionally, a first decanter for enriching a solid material from a process stream remaining at the end of fermentation;

an explosion cylinder for processing the enriched solids to extract lignin therefrom into a liquid phase;

a capture chamber for receiving the liquid phase; and

optionally, a second decanter for recovering lignin from the liquid phase.

In some embodiments, ethanol and steam can be provided to the explosion cylinder. The operation conditions can be approximately 180° C. to 220° C. and approximately 10 to 35 atmospheres of pressure. The capture chamber can operate at approximately 1 bar. Ethanol can be boiled off in the capture chamber at, e.g., 94° C. Lignin can precipitate while boiling in the capture chamber. In the second decanter lignin precipitates can be separated by centrifuge and/or filtration, while the remaining liquid phase (containing ethanol and water) can be recycled.

A further aspect relates to a lignin product produced by the processes and/or systems disclosed herein.

### BRIEF DESCRIPTION OF THE DRAWINGS

FIG. 1 illustrates the general process flow of ethanol production in which lignocellulosic biomass is used as the starting material.

FIG. 2 illustrates, in an embodiment of the present disclosure, the general process flow ethanol production followed by a process for the hydrolysis, dissolution and recovery of lignin that is applied to the lignocellulosic solids leaving the fermentor.

FIG. 3 illustrates an exemplary system and exemplary temperatures and pressures used in the “organosolv steam explosion” operations of the process.

### DETAILED DESCRIPTION

The present disclosure advantageously provides methods and systems to recover lignin from the post-fermentation solids, following production of bio-based chemicals from lignocellulosic biomass. The recovered lignin can be used in further commercial processes to, e.g., supplement or replace petroleum feedstocks. As the post-fermentation lignin is still associated with some carbohydrates of the original lignocellulosic biomass, a further deconstruction process can be used to dissociate the lignin from the carbohydrate, and depolymerize the naturally high molecular weight lignin polymer into smaller lignin fragments in the 300 to 4,000 Dalton range.

In some embodiments, a novel process for post-fermentation lignin recovery is provided herein, comprising:
i) a fermentive process of ethanol or other biofuels or bio-based chemicals from lignocellulosic biomass, including a pre-treatment process for deconstructing the lignocellulosic biomass,
ii) steam explosion for the (partial) breakdown of the solid materials remaining at the end of the fermentive process, and
iii) organosolv technology for solubilization and hydrolysis of lignin,

It should be noted that the process described herein is applied to the solids remaining after the fermentive production of ethanol or other biofuels or bio-based chemicals (e.g., n-butanol, iso-butanol, lactic acid, polyhydroxyalkanoates, succinic acid, 1,3-propanediol and 1,4-butanediol), thus significantly and advantageously reducing the mass of material handled. The reduction in the mass of materials handled permits the use of smaller, more cost-effective equipment for biomass treatment/deconstruction than those typically used in pre-treatment processes of the fermentive production of biofuels or bio-based chemicals.

The process disclosed herein not only recovers high-quality, sulfur-free lignin, but also unfermented carbohydrates. In one embodiment, this process may be used to recover recalcitrant amounts of cellulose or hemi-cellulose that failed to undergo conversion to fermentable sugars in the initial biomass pre-treatment and saccharification steps. In some embodiments, such recovered carbohydrates can be returned to the initial pre-treatment process and/or to the fermentation process.

In one embodiment, lignin can be solubilized via a combination of technology now used for the breakdown of sewage sludge, for example, steam explosion, coupled with a solvent pulping process that requires high temperatures and pressures in a range similar to the technology currently practiced for the breakdown of sewage sludge. The solubilized lignin can then be precipitated by the addition of water to the solvent-containing process stream, and the solvent recovered and recycled. The solvent can be one or more of ethanol, methanol, acetone, acetic acid, formic acid, or any combinations thereof. In one example, the solvent used is ethanol.

In another preferred embodiment, the spent cells from the fermentation are separated from the other solids prior to the use of a steam explosion or solvent hydrolysis process. The recovered cell mass may be used as cattle feed or for other instances in which a material with high protein content is desired.

In some embodiments, the entire process can be run in a facility practicing the fermentation of lignocellulosic biomass to ethanol or other biofuel or bio-based chemical process.

In one embodiment, the solvent used is ethanol and the entire process is conducted at a facility practicing the production of ethanol from lignocellulosic biomass, and in which facility the ethanol for the solvent of the organosolv technology is supplied by the facility itself, and the aqueous ethanol solvent recovered after precipitation and recovery of the lignin material is returned to the ethanol distillation process for recovery of the ethanol.

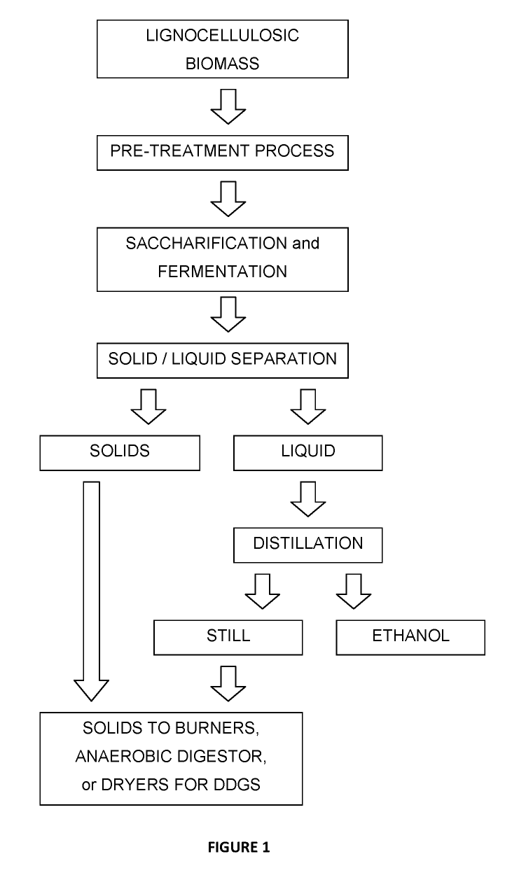

Referring to FIG. 1, a general process flow of ethanol production is illustrated in which lignocellulosic biomass is used as the starting material. The lignocellulosic biomass is first subject to pre-treatment. As used herein, “pre-treatment” and “pre-treatment processes” refer to a wide variety of methods for deconstructing the natural occurring arrangements of cellulose, hemi-cellulose and lignin. These pre-treatment processes are summarized in “Literature Review of Physical and Chemical Pretreatment Processes for Lignocellulosic Biomass,” Harmsen et al., Energy Research Center of the Netherlands, ECN-E-10-013, 2010, which is incorporated herein by reference.

Still referring to FIG. 1, following pre-treatment, the deconstructed biomass is subjected to saccharification to produce fermentable sugars which are then subject to fermentation. Thereafter, the resulting mixture of solids and liquid is separated, with the liquid portion subjected to distillation to produce ethanol, while all solids going to burners, anaerobic digestor or dryers for distillers dried grains with solubles (DDGS).

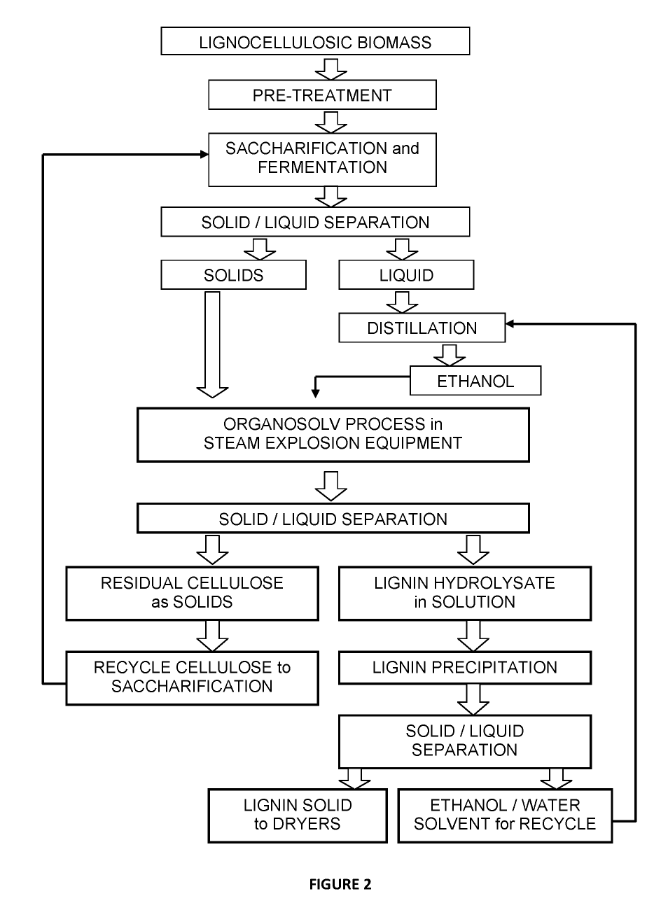

In an embodiment of the present disclosure as illustrated in FIG. 2, a post-fermentation process is added to recover lignin from the fermentive ethanol production of FIG. 1. In contrast to conventional methods, the solids remaining at the end of fermentation are subjected to an organosolv process, optionally in a steam explosion equipment. The ethanol produced from the fermentation can be optionally used as a solvent for the organosolv process.

“Organoso v” refers to the treatment of biomass with an aqueous organic solvent at elevated temperatures. Commonly used solvents are ethanol, methanol, acetone and organic acids like acetic acid and formic acid or combinations thereof. Organosolv processes delignify lignocellulose, with the organic solvent functioning as lignin extractant, while the hemicellulose is depolymerized through acid-catalysed hydrolysis. In general, organosolv processes aim to fractionate the lignocellulosic biomass as much as possible into its individual major fractions in contrast to other pre-treatment technologies such as steam explosion and dilute acid hydrolysis. The latter technologies merely make the cellulose fraction suitable for further processing without recovery of a purified lignin fraction.

Certain organosolv methods have been described, see for example U.S. Pat. No. 5,730,837 and the patents referenced therein. These processes dissolve the lignin and hemicellulose present in lignocellulosic biomass in a solvent, allowing the recovery of the cellulose as a solid material. The lignin and hemi-cellulose may be recovered from the solvent in other process steps. Most typical is the organosolv process that employs a mixture of water and ethanol as the solvent. Such a process was developed by Alcell technologies (U.S. Pat. Nos. 4,100,016 and 4,764,596; WO96/41052; Williamson et al, “Repap's Alcell Process: How it Works and What it Offers”, Pulp and Paper Canada, December 1978, pp. 47-49; Lora et al., Proceedings of the TAPPI 1984 Research and Development Conference, Appleton Wis., 1984, pp 162-177; all incorporated herein by reference). Organosolv processes have also been disclosed by Lignol (U.S. Pat. Nos. 7,465,791, 8,193,324, 8,227,004, and 8,528,463; all incorporated herein by reference).

In some embodiments of the present disclosure, the organosolv process uses ethanol, or other solvent (e.g., methanol, acetone, acetic acid and formic acid), under high temperatures and pressures to partially depolymerize and solubilize the lignin in the solids. The operating pressure can be in the 10-35 or 20-35 or about 13 bar range with a temperature of range of approximately 180-250° C. or 180-220° C. In one embodiment, the solids remaining in the cellulosic fermenter are sent to the organosolv process with a mixture of water and ethanol, at approximately 180° C. to 220° C. and approximately 20 to 35 atmospheres of pressure.

In some embodiments, organosolv can be facilitated by concurrent or subsequent steam explosion. In general “steam explosion” or “flashing” refers to a process in which biomass is treated with hot steam (e.g., 180 to 240° C.) under pressure (e.g., 1 to 3.5 MPa) at short contact times (e.g., 1-20 min) followed by rapid pressure release and an explosive decompression of the biomass that results in a rupture of the biomass fibers rigid structure. The sudden pressure release defibrillates the cellulose bundles, and this result in a better accessibility of the cellulose for enzymatic hydrolysis and fermentation. Certain biomass steam explosion methods and systems are disclosed in U.S. Pat. Nos. 8,673,112 and 8,506,716, both incorporated herein by reference.

Steam explosion technology is now used for the treatment of sewage sludge prior to the sludge being fed to an anaerobic digester. The existing commercial-scale equipment used for performing the steam explosion process on sewage sludge is capable of generating the temperature and pressure environments required for the organosolv process that produces sulfur-free lignin.

Steam explosion systems and related commercial experience in waste treatment may be applied to the extraction and recovery of lignin from the residual solids resulting from the fermentation step in a cellulosic ethanol production facility.

In embodiments where organosolv is facilitated by steam explosion, rapid pressure release is used, as opposed to conventional organosolv methods where pressure is released slowly. This is advantageous because the rapid pressure drop causes the microbial cells to lyse and it further disrupts the physical structure of the undigested cellulose making the fibers in the recycled stream more readily susceptible to enzymatic hydrolysis. In one embodiment, organosolv takes place in a steam explosion equipment.

Referring to FIG. 2, after steam explosion and pressure reduction, the process stream is centrifuged or filtered to remove the solid material from the solvent stream containing the solubilized lignin or lignin hydrolysate. These solids are mainly cellulosic material or residual cellulose that was not saccharified prior to fermentation. These solids can be recycled back to the pretreatment and/or saccharification steps for further fermentation.

The lignin oligomers are then precipitated from the solvent/liquid stream and recovered to provide high-quality, sulfur-free lignin. Precipitation of lignin can be achieved by simply boiling off the solvent. Precipitation of lignin can also be effected by dilution (e.g., 1 or 2 or 3 times) with acidified water. The lignin precipitates and forms spherical aggregates ranging from, e.g., 0.5-2.5 μm. Filtration can then be used to collect lignin precipitates, which, in some embodiments, can be more effective while the mixture is hot (>100° C.). Recovery can also be achieved by centrifugation. Due to the hydrophobic nature of organosolv lignin, flotation of organosolv lignin can be effective without the use of the collecting and precipitating agents.

The recovered lignin is subsequently dried for, e.g., shipment as a powder. The solvent can be recovered and recycled. The remaining solids from the centrifuge or filtration step can be returned to the cellulosic ethanol process or used as a feedstock to an anaerobic digester or as fuel in a boiler.

The cell mass remaining at the end of fermentation (“spent cell”), if it is separated, can be combined with the solids and the mixture used as cattle feed.

It should be noted that while FIGS. 1-2 refer to ethanol fermentive production, the general process flow is equally applicable to the production of other biofuels and bio-based chemicals.

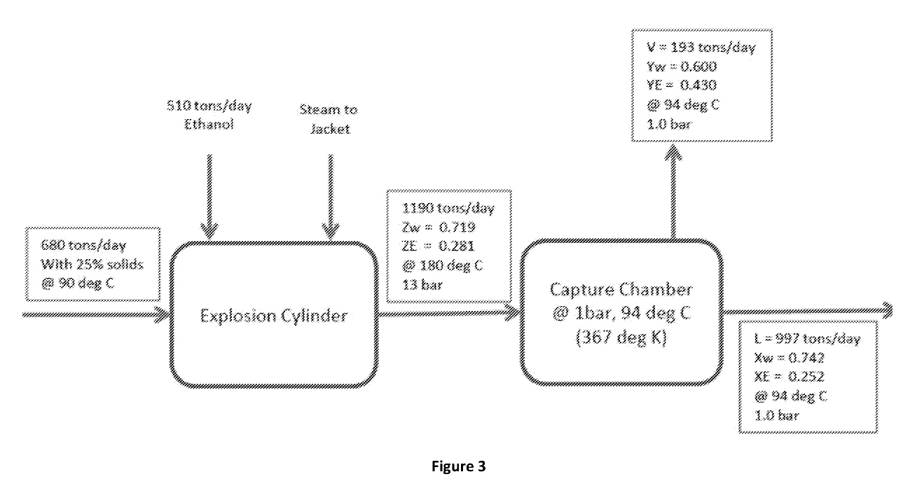

FIG. 3 illustrates an exemplary system and exemplary temperatures and pressures used in the “organosolv steam explosion” operations of the process. Briefly, a process stream containing solids (e.g., 1-50% or 5-20% or about 8%) remaining at the end of fermentation can be optionally fed to a decanter (not shown), to separate or enrich solids from the liquid phase. The liquid phase can be subjected to distillation to collect ethanol. The enriched solids (e.g., 10-80% or 20-50% or about 25%) can be sent to an explosion cylinder where organosolv steam explosion takes place. Ethanol and steam can be provided to the explosion cylinder. The operation conditions can be approximately 180° C. to 220° C. and approximately 10 to 35 atmospheres of pressure. Thereafter, the process stream is moved to a capture chamber following rapid pressure release to 1 bar. Ethanol can be boiled off in the capture chamber at, e.g., 94° C. Lignin starts to precipitate while boiling. The process stream containing lignin precipitates can optionally be moved to a downstream decanter (not shown) where lignin solids can be separated by centrifuge and/or filtration, while the liquid phase (containing ethanol and water) can be recycled.

As used herein, the term “about” or “approximately” means the usual error range for the respective value readily known to the skilled person in this technical field, e.g., within 20%, more preferably within 10% and most preferably within 5%.

As used herein, “including,” “comprising,” “having,” “containing,” “involving,” and variations thereof, are meant to encompass the items listed thereafter and equivalents thereof as well as additional items. “Consisting of” shall be understood as a close-ended relating to a limited range of elements or features. “Consisting essentially of” limits the scope to the specified elements or steps but does not exclude those that do not materially affect the basic and novel characteristics of the claimed invention.

### EQUIVALENTS

The present disclosure provides among other things novel methods for producing high-quality lignin in the molecular weight range of 300-4,000 Daltons from post-fermentation lignocellulosic residual materials. While specific embodiments of the subject disclosure have been discussed, the above specification is illustrative and not restrictive. Many variations of the disclosure will become apparent to those skilled in the art upon review of this specification. The full scope of the disclosure should be determined by reference to the claims, along with their full scope of equivalents, and the specification, along with such variations.

### INCORPORATION BY REFERENCE

All publications, patents and patent applications cited above are incorporated by reference herein in their entirety for all purposes to the same extent as if each individual publication or patent application were specifically indicated to be so incorporated by reference.

1. A process for producing lignin, comprising :
providing a solid material remaining at the end of a fermentation process, wherein the fermentation process utilizes a lignocellulosic biomass feedstock;
extracting lignin from the solid material into a liquid phase; and
recovering lignin from liquid phase.

2. The process of claim 1, wherein the fermentation process produces one or more of ethanol, n-butanol, iso-butanol, lactic acid, polyhydroxyalkanoates, succinic acid, 1,3-propanediol and 1,4-butanediol.

3. The process of claim 1 wherein the extracting step operates at approximately 180° C. to 220° C. and approximately 20 to 35 atmospheres of pressure, optionally in the presence of an organic solvent.

4. The process of claim 3 wherein the organic solvent is ethanol.

5. The process of any one of claims 1-4 wherein the extracting step takes place in a steam explosion equipment.

6. The process of claim 1 further comprising removing spent cells from the fermentation process, prior to the extracting step.

7. The process of claim 1, wherein the recovering step comprises precipitating lignin by adding water to the liquid phase and/or boiling off the solvent.

8. The process of claim 1 further comprising recovering a carbohydrate material following the extracting step.

9. The process of claim 8 further comprising recycling the carbohydrate material back to the fermentation process.

10. A lignin product produced by a process of any of claims 1-9.

11. A process for producing lignin, comprising :
optionally, a first decanter for enriching a solid material from a process stream remaining at the end of fermentation;
an explosion cylinder for processing the enriched solids to extract lignin therefrom into a liquid phase;
a capture chamber for receiving the liquid phase; and
optionally, a second decanter for recovering lignin from the liquid phase.
